(19) United States
(12) Patent Application Publication
(10) Pub. No.: US 2014/0238181 A1
(43) Pub. Date: Aug. 28, 2014

(54) ACCELERATOR PEDAL DEVICE

(71) Applicants: Meguru Kashiyama, Odawara (JP); Masato Kumamoto, Odawara (JP)

(72) Inventors: Meguru Kashiyama, Odawara (JP); Masato Kumamoto, Odawara (JP)

(73) Assignee: MIKUNI CORPORATION, Tokyo (JP)

(21) Appl. No.: 14/236,738

(22) PCT Filed: Jul. 26, 2012
(86) PCT No.: PCT/JP2012/068929

§ 371 Date: Feb. 3, 2014

(30) Foreign Application Priority Data
Aug. 2, 2011 (JP) 2011-168898

(51) Int. Cl. G05G 1/44

(52) U.S. Cl. CPC G05G 1/44
USPC 74/513

(57) ABSTRACT

An accelerator pedal device includes a slide guide path which is formed in a housing, a first slider which is engaged with the pedal arm for receiving pedaling force as being slidably arranged in the slide guide path and which includes a first inclined face inclined against a movement direction of the first slider, a second slider which is slidably arranged in the slide guide path and which includes a second inclined face contacted to the first inclined face, and an urging spring which exerts urging force in a direction opposing to the pedaling force as being engaged with the second slider, wherein the slide guide path is formed as being tapered in a direction of movement of the first slider and the second slider which are moved in association with depression of the accelerator pedal. Accordingly, desired hysteresis can be obtained on the pedaling force while achieving downsizing.

### TECHNICAL FIELD

The present invention relates to an accelerator pedal device applied to a vehicle of the like, and in particular, relates to an accelerator pedal device applied to a vehicle or the like having a drive-by-wire system.

### BACKGROUND ART

There has been conventionally known an accelerator pedal device including a housing (support case) which is fixed to a vehicle body of an automobile or the like, a pedal arm (accelerator arm) which is swingably supported by the housing as integrally including an accelerator pedal, a return spring which returns the pedal arm to a rest position, a hysteresis generating mechanism which generates hysteresis at pedaling force (pedaling load), an accelerator sensor which detects a rotational amount of the pedal arm as accelerator opening, and the like. Here, the hysteresis generating mechanism includes two frictional pieces (a frictional piece and a subsidiary frictional piece) with inclined faces thereof mutually contacted to provide a wedge action as being interposed between a leading end part of the pedal arm and the return spring, and two parallel flat inner faces formed in the housing to which flat outer faces of the two frictional pieces are contacted for slidable guiding (for example, see Patent Literature 1).

In this accelerator pedal device, when the pedal arm is depressed against the urging force of the return spring, a wedge action is generated with one frictional piece digging into the other frictional piece, and both the frictional pieces are integrally moved as having the outer face of each slid on the corresponding inner face of the housing. Thus, load is applied on the pedaling force and hysteresis is generated at the pedaling force between a depression process and a return process.

However, after the two frictional pieces mutually dug to provide a wedge action, the abovementioned hysteresis generating mechanism uses only frictional force generated while the outer faces of the two frictional pieces which are not relatively moved are moved relatively against the inner faces of the housing as being contacted thereto. Here, when such a mechanism is downsized, there is a fear that desired hysteresis characteristics cannot be obtained with insufficient friction force, that is, insufficient load on the pedaling force.

### CITED LITERATURE

### Patent Literature

Patent Literature 1: Japanese Patent Application Laid-Open No. 2005-239047

### SUMMARY OF THE INVENTION

To address the above issues, an object of the present invention is to provide an accelerator pedal device which is capable of providing desired hysteresis characteristics while achieving simplification of structure, reduction in component count, cost reduction, downsizing of the whole device, downsizing of the hysteresis generating mechanism, and the like.

An accelerator pedal device according to the present invention includes a pedal arm which is moved in association with an accelerator pedal; a housing which supports the pedal arm between a rest position and a maximum depression position as being pivotable about a predetermined axis line; and a hysteresis generating mechanism for generating hysteresis at pedaling force of the accelerator pedal as including a slide guide path which is formed in the housing, a first slider which is engaged with the pedal arm for receiving pedaling force as being slidably arranged in the slide guide path and which includes a first inclined face inclined against a movement direction of the first slider, a second slider which is slidably arranged in the slide guide path and which includes a second inclined face contacted to the first inclined face, and an urging spring which exerts urging force in a direction opposing to the pedaling force as being engaged with the second slider. Here, the slide guide path is formed as being tapered in a direction of movement of the first slider and the second slider which are moved in association with depression of the accelerator pedal.

According to the configuration, when the accelerator pedal is depressed and the pedal arm is rotated in the depression direction, the first inclined face of the first slider presses the second inclined face of the second slider. Consequently, owing to a wedge action therebetween, the first slider and the second slider are moved against urging force of the urging spring while being pressed to the slider guide path. Further, since the slide guide path is tapered, the first slider and the second slider are relatively slid to be mutually closed to the center of the slide guide path.

Accordingly, as the friction force during movement from the rest position toward the maximum depression position, the friction force between (the first inclined face of) the first slider and (the second inclined face of) the second slider is exerted in addition to the friction force between the first slider and the slide guide path having the inclined face and the friction force between the second slider and the slide guide path having the inclined face. Consequently, the friction force can be increased by the amount thereof. On the other hand, when the accelerator pedal is returned and the pedal arm is rotated in the returning direction, the first slider and the second slider are returned in accordance with the urging force of the urging spring. Here, since the first slider and the second slider are moved toward a release side to be free, the friction force during movement from the maximum depression position toward the rest position is decreased.

Accordingly, even when the hysteresis generating mechanism (the slide guide path, the first slider, the second slider, the urging spring, and the like) is downsized, desired hysteresis can be obtained at the pedaling force while the friction force during depression is increased.

In the above structure, it is possible to adopt a configuration that the first slider includes a first slide face which is slidably contacted to the slide guide path, the second slider includes a second slide face which is slidably contacted to the slide guide path, and the slide guide path includes an inner wall face which slidably guides the first slide face and the second slide face.

According to the configuration, since the first slider is slid with face contact to the inner wall face of the slide guide path via the first slide face thereof and the second slider is slid with face contact to the inner wall face of the slide guide path via the second slide face thereof, stable friction force is generated and desired hysteresis can be obtained at the pedaling force.

In the above structure, it is possible to adopt a configuration that the first slide face and the second slide face are formed as being flat-face-shaped, and the slide guide face is formed to define a first inclined inner face wall having a flat face shape to which the first slide face of the first slider is slidably contacted and a second inclined inner wall face having a flat face shape to which the second slide face of the second slider is slidably contacted.

According to the configuration, since the first slide face of the first slider is slid with face contact in a flat face shape manner to the first inclined inner wall face of the slide guide path and the second slide face of the second slider is slid with face contact in a flat face shape manner to the second inclined inner wall face of the slide guide path, occurrence of sticking (biting) and the like can be prevented and stable friction force can be obtained with smooth sliding operation.

In the above structure, it is possible to adopt a configuration that the first slide face and the second slide face are formed as being curved-face-shaped, and the slide guide face is formed to define a cone-shaped inner wall face to which the first slide face of the first slider and the second slide face of the second slider are slidably contacted.

According to the configuration, since the first slide face of the first slider and the second slide face of the second slider are slid with face contact in a curved face shape manner to the cone-shaped inner wall face of the slide guide pat, the first slider and the second slider can be automatically centered. Consequently, stable friction force can be obtained.

In the above structure, it is possible to adopt a configuration that the housing includes a cylindrical portion which defines the slide guide path with one end thereof opened, and the first slider, the second slider, and the urging spring are arranged at the cylindrical portion.

According to the configuration, the hysteresis generating mechanism can be structured only by fitting the urging spring into the cylindrical portion of the housing, fitting the second slider from the outer side thereof, and fitting the first slider further from the outer side thereof. Thus, it is possible to achieve simplification of assembling operation, simplification of the structure, and downsizing of the mechanism and the device.

In the above structure, it is possible to adopt a configuration that the device includes a return spring which exerts urging force to return the pedal arm to the rest position, and the pedal arm includes a contact portion which is disengageably contacted to the first slider.

According to the configuration, even in a case that the first slider and the second slider are not returned as being stuck (locked), the pedal arm (accelerator pedal) can be reliably returned to the rest position.

In the above structure, it is possible to adopt a configuration that the device includes an active control mechanism including a return lever which exerts returning force to the pedal arm as being contacted thereto for controlling the pedal arm to be pushed back toward the rest position under predetermined conditions, and a drive source which drives the return lever, the pedal arm includes an upper arm which is positioned above the predetermined axis line, and a lower arm which is positioned below the predetermined axis line, the return lever is formed to be engaged with the upper arm, and the contact portion is formed at the lower arm.

According to the configuration, even in a case that the active control mechanism is arranged in the housing, the device (housing) can be downsized as a whole by arranging the hysteresis generating mechanism in an area at the lower arm.

According to the accelerator pedal device having the abovementioned structure, it is possible to obtain desired hysteresis characteristics while achieving simplification of structure, reduction in component count, cost reduction, downsizing of the whole device, downsizing of the hysteresis generating mechanism, and the like.

### BRIEF DESCRIPTION OF THE DRAWINGS

FIG. 1 is a perspective view illustrating an embodiment of an accelerator pedal device according to the present invention.

FIG. 2 is an exploded perspective view of the accelerator pedal device in FIG. 1.

FIG. 3 is an exploded perspective view of the accelerator pedal device in FIG. 1.

FIG. 4 is an exploded perspective view of the accelerator pedal device in FIG. 1.

FIG. 5 is a partial exploded perspective view of the accelerator pedal device in FIG. 1.

FIG. 6 is a partial sectional view illustrating a structure of a position sensor which is included in the accelerator pedal device in FIG. 1.

FIG. 7 is an exploded perspective view illustrating a hysteresis generating mechanism which is included in the accelerator pedal device in FIG. 1.

FIG. 8 is a partial sectional view illustrating the hysteresis generating mechanism which is included in the accelerator pedal device in FIG. 1.

FIG. 9 is a characteristic diagram indicating hysteresis characteristics of pedaling force of the accelerator pedal device in FIG. 1.

FIG. 10 is an exploded perspective view illustrating another embodiment of a hysteresis generating mechanism included in an accelerator pedal device according to the present invention.

FIG. 11 is a partial sectional view of the hysteresis generating mechanism in FIG. 10.

### EMBODIMENT OF THE INVENTION

In the following, embodiments of the present invention will be described with reference to the attached drawings.

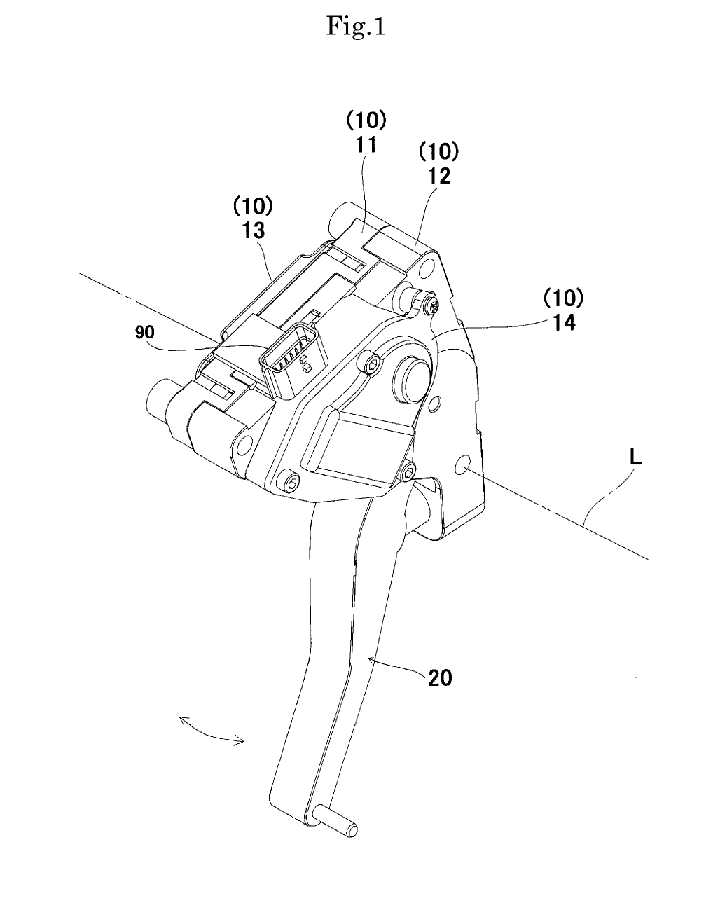

As illustrated in FIGS. 1 to 5, an accelerator pedal device includes a housing 10 which is fixed to a vehicle body of an automobile or the like, a pedal arm 20 which is pivotably supported about a predetermined axis line L defined by the housing 10 as being moved in association with an accelerator pedal (not illustrated), a return spring 30 which exerts urging force to return the pedal arm 20 to a rest position, a hysteresis generating mechanism 40 (a slide guide path 12j′, a first slider 41, a second slider 42, and an urging spring 43) which generates hysteresis at pedaling force (pedaling load) of the accelerator pedal, an active control mechanism 50 (a drive source 51 (a rotor 51a, a coil 51b, and a yoke 51c), and a return lever 52) which generates push-back force to push back the pedal arm 20 toward the rest position under predetermined conditions, a position sensor 60 (an armature 61, permanent magnets 62, stators 63, and Hall elements 64) which detects a rotational angular position of the pedal arm 20, a temperature sensor 70 which detects temperature of the active control mechanism 50 (coil 51b), a control circuit board 80, a connector 90 which is electrically connected to the control circuit board 80, and the like.

As illustrated in FIGS. 1 to 4, the housing is structured with a first housing main body 11, a second housing main body 12, a first housing cover 13, and a second housing cover 14.

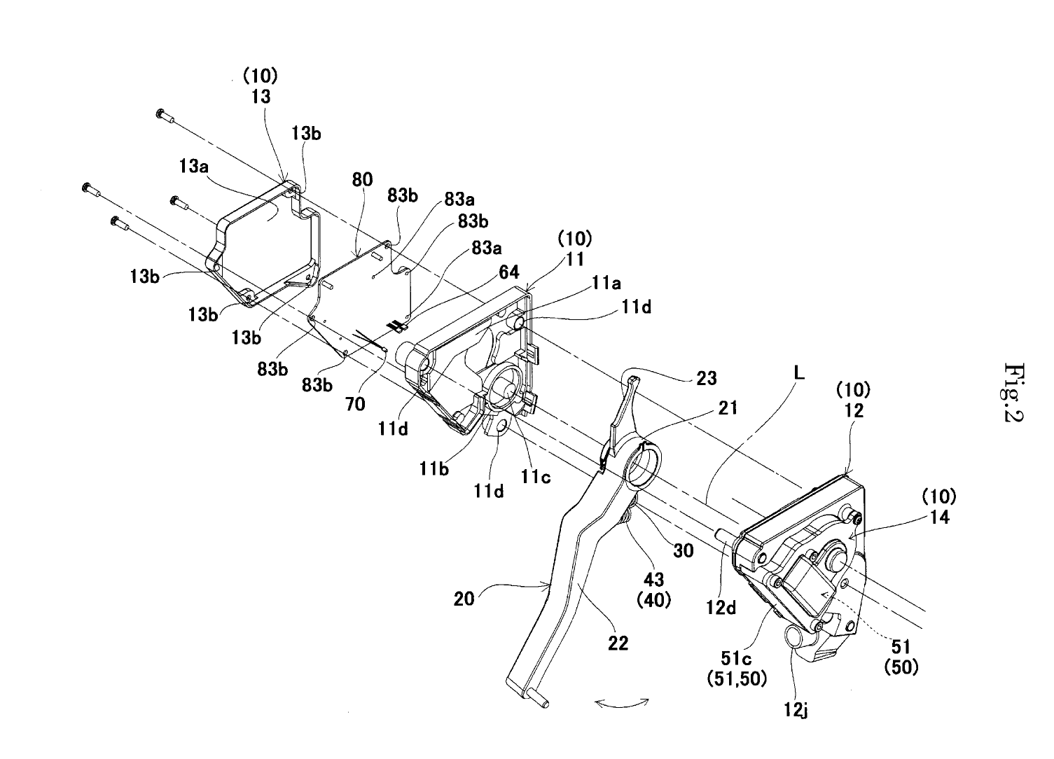

The first housing main body 11 is formed of a resin material. As illustrated in FIGS. 2 to 4, the first housing main body 11 includes a side wall portion 11a, a cylinder-shaped bearing portion 11b which is arranged coaxially with the axis line L at the inner side of the side wall portion 11a, a columnar portion 11c which is protruded to the inner side in a direction of the axis line L at a center of the bearing portion 11b and which is formed concavely toward the outer side of the side wall portion 11a, a plurality of connecting holes 11d for connecting the second housing main body 12, a plurality of positioning pins 11e which performs positioning for attaching the control circuit board 80 as being formed at the outer side of the side wall portion 11a, a plurality of screw holes 11f for connecting the first housing cover 13 as being formed at the outer side of the side wall portion 11a, a plurality of terminals 11g which are embedded in the side wall portion 11a for electrically connecting the coil 51b for magnetization included in the active control mechanism 50 to the control circuit board 80, a plurality of connecting pieces 11h for connecting the second housing main body 12, a full-open stopper 11i which defines a maximum depression position of the pedal arm 20, and the like.

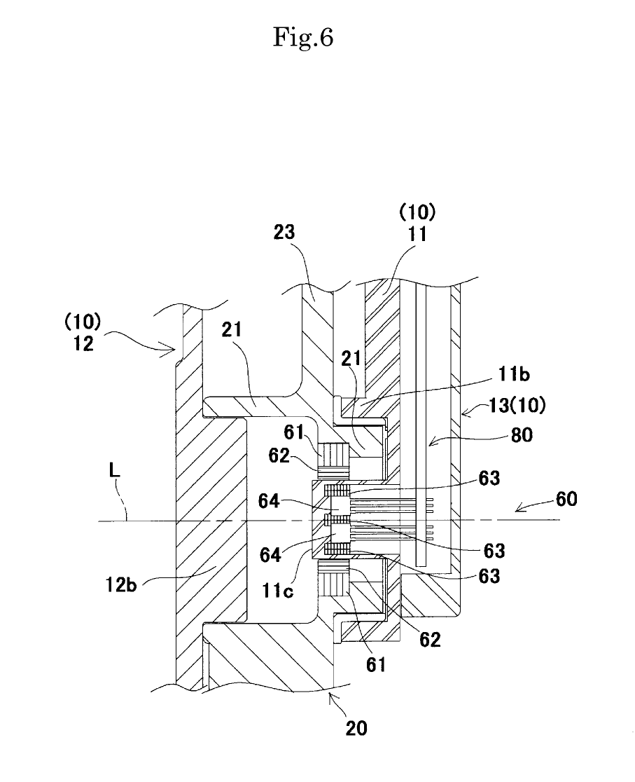

As illustrated in FIG. 6, the columnar portion 11c is formed coaxially with the bearing portion 11b as being centered on the axis line L. Here, the columnar portion 11c is formed to be non-contacted to the ring-shaped armature 61 and a pair of the arc-shaped permanent magnets 62 which are fixed to an inner circumferential face of a cylindrical portion 21 of the pedal arm 20 in a state that the bearing portion 11b is fitted to the cylindrical portion 21.

The second housing main body 12 is formed of a resin material. As illustrated in FIGS. 2 to 5, the second housing main body 12 includes a side wall portion 12a, a column-shaped bearing portion 12b which is arranged coaxially with the axis line L at the inner side of the side wall portion 12a, a plurality of fitting projections 12d for connecting the first housing main body 11, an attaching concave portion 12e for attaching the drive source 51 (the coil 51b and the yoke 51c) as being formed at the outer side of the side wall portion 12a, screw holes 12f for attaching the yoke 51c, a bearing hole 12g which pivotably supports a rotational shaft 51a′ of the rotor 51a, an opening portion 12h through which the coil 51b passes, a receiving portion 12i which receives one end part of the return spring 30, a cylindrical portion 12j which defines a slide guide path 12j′ with one end thereof opened for arranging (the first slider 41, the second slider 42, and the urging spring 43 of) the hysteresis generating mechanism 40, screw holes 12k for connecting the second housing cover 14, a plurality of connecting pawls 12m for connecting the first housing main body 11, and the like.

The first housing cover 13 is formed of resin material. As illustrated in FIGS. 2 to 4, the first housing cover 13 includes a side wall portion 13a, a plurality of screw holes 13b, and the like. The first housing cover 13 is formed to be connected in a detachably attachable manner to the first housing main body 11 so as to hold the control circuit board 80 in a state of sandwiching and covering in cooperation with the first housing main body 11.

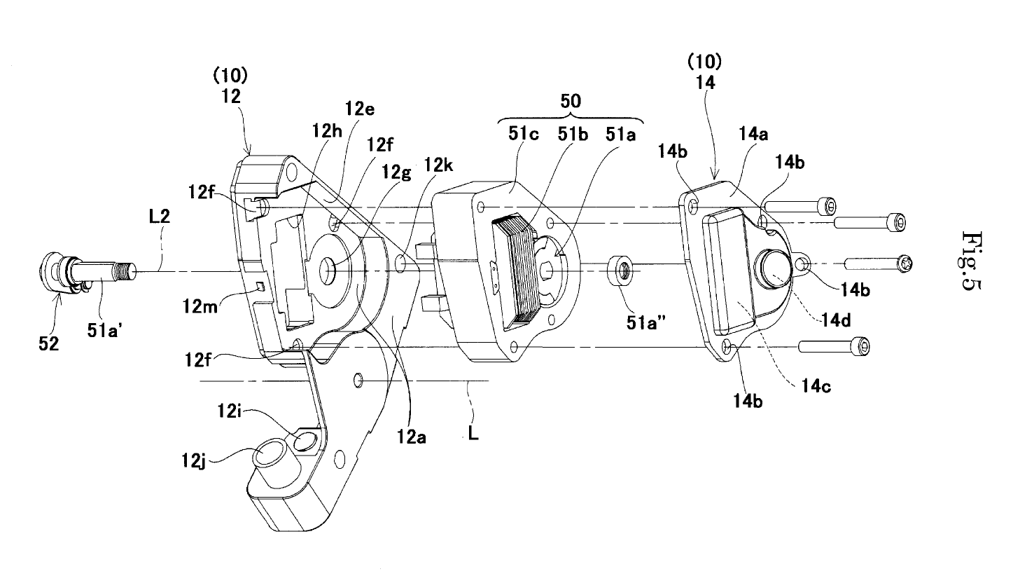

The second housing cover 14 is formed of a metal material (e.g., aluminum) to have enhanced radiation performance. As illustrated in FIG. 5, the second housing cover 14 includes a side wall portion 14a, a plurality of screw holes 14b, a concave portion 14c swelled outward to accommodate the coil 51b, a bearing portion 14d which pivotably supports a side of an end part (nut 51a″) of the rotor 51a, and the like. The second housing cover 14 is formed to be connected in a detachably attachable manner to the second housing main body 12 and the yoke 51c so as to hold the drive source 51 in a state of sandwiching and covering (with a partial exception) in cooperation with the second housing main body 12.

The pedal arm 20 is formed with resin material in whole. As illustrated in FIGS. 2 to 6, the pedal arm 20 includes the cylindrical portion 21 which is pivotably supported by the bearing portions 11b, 12b of the housing 10 (the first housing main body 11 and the second housing main body 12), a lower arm 22 which is integrally formed with the cylindrical portion 21 as being extended downward therefrom (as being positioned below the axis line L) and which is connected to an accelerator pedal (not illustrated) as being moved in association therewith via a linkage mechanism and the like, an upper arm 23 which is integrally formed with the cylindrical portion 21 as being extended upward therefrom (as being positioned above the axis line L), a receiving portion 24 which receives other end part of the return spring 30 as being formed at the lower arm 22 in the vicinity below the cylindrical portion 21, a rod-shaped contact portion 25 which is contacted to a first slider 41 of the hysteresis generating mechanism 40 as being formed in the vicinity below the receiving portion 24, and the like.

As illustrated in FIG. 6, the bearing portion 11b of the first housing main body 11 is fitted to the outside of a small-diameter portion of the cylindrical portion 21 and the bearing portion 12b of the second housing main body 12 is fitted to the inside of a large-diameter portion of the cylindrical portion 21. Accordingly, the cylindrical portion is pivotably supported about the axis line L.

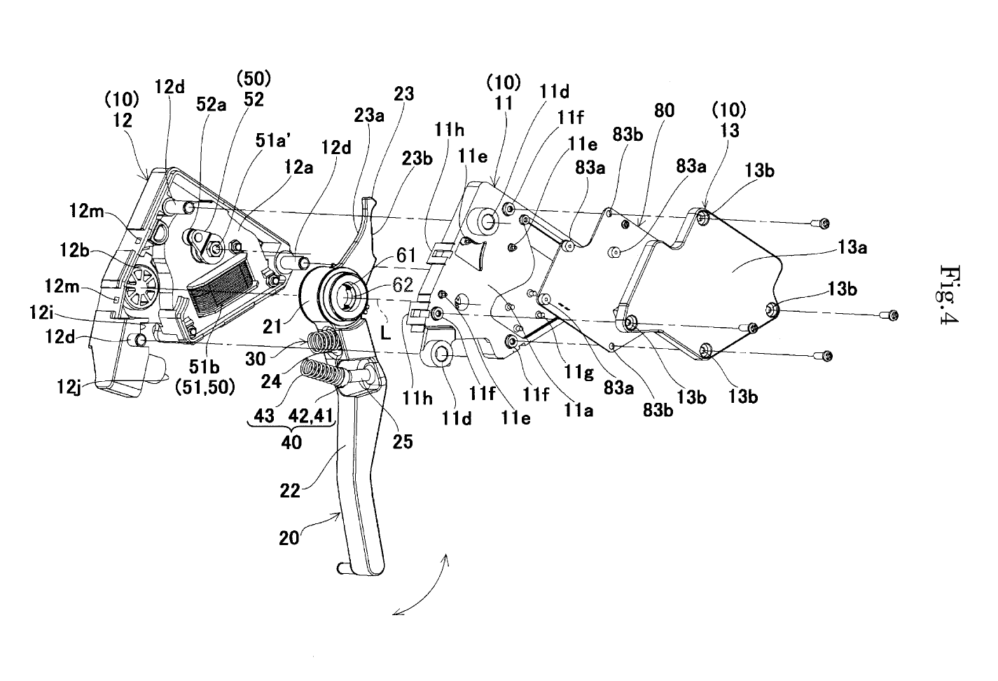

Further, as illustrated in FIGS. 4 and 6, the ring-shaped armature 61 formed of a magnetic material and the pair of arc-shaped permanent magnets 62 connected to an inner circumferential face of the armature 61 are arranged at an inner circumferential face of the small-diameter portion of the cylindrical portion 21.

The upper arm 23 is formed such that the pedal arm 20 is positioned at the rest position, in a state that the pedal arm 20 is pivotably sandwiched by the first housing main body 11 and the second housing main body 12, while a rim portion 23a of the upper arm 23 is contacted to the fitting projection 12d which is arranged at the vicinity of the return lever 52 owing to the urging force of the return spring 30 and that the return lever 52 is contacted to a rim portion 23b to push back the pedal arm 20 toward the rest position.

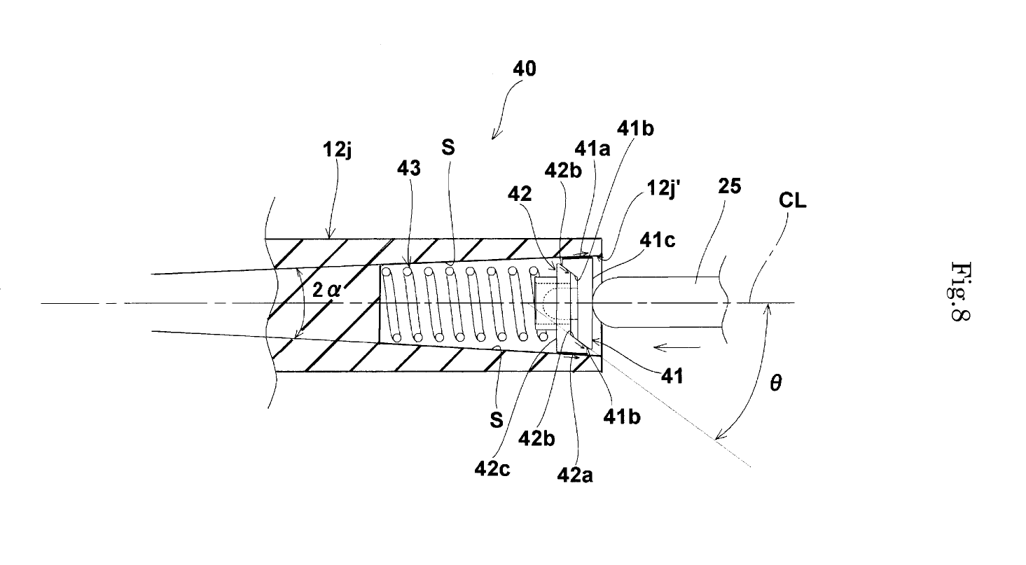

As illustrated in FIG. 8, the contact portion 25 is formed so as to be disengageably contacted to the first slider 41 of the hysteresis generating mechanism 40 which is arranged in the cylindrical portion 12j so that the first slider 41 and the second slider 42 are compressed against the urging force of the urging spring 43.

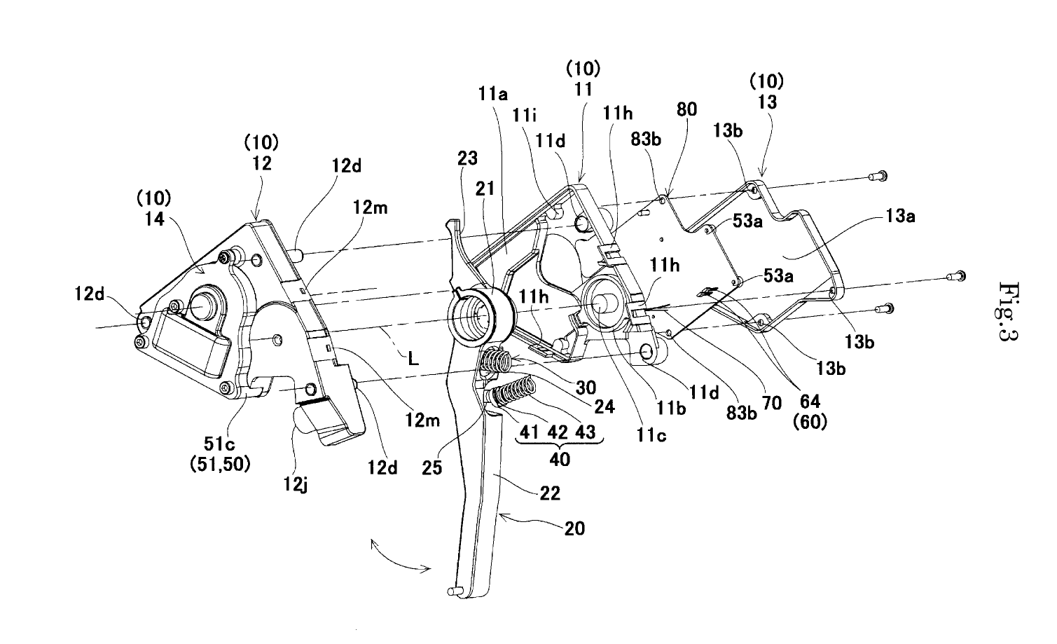

As illustrated in FIGS. 3 and 4, the return spring 30 is a compression-type coil spring formed of spring steel or the like. The return spring 30 is arranged in a state of being compressed having a predetermined compression amount with one end part thereof being contacted to the receiving portion 12i of the second housing main body 12 and the other end part being contacted to the receiving portion 24 of the pedal arm 20. Accordingly, the return spring 30 exerts urging force to return the pedal arm 20 to the rest position.

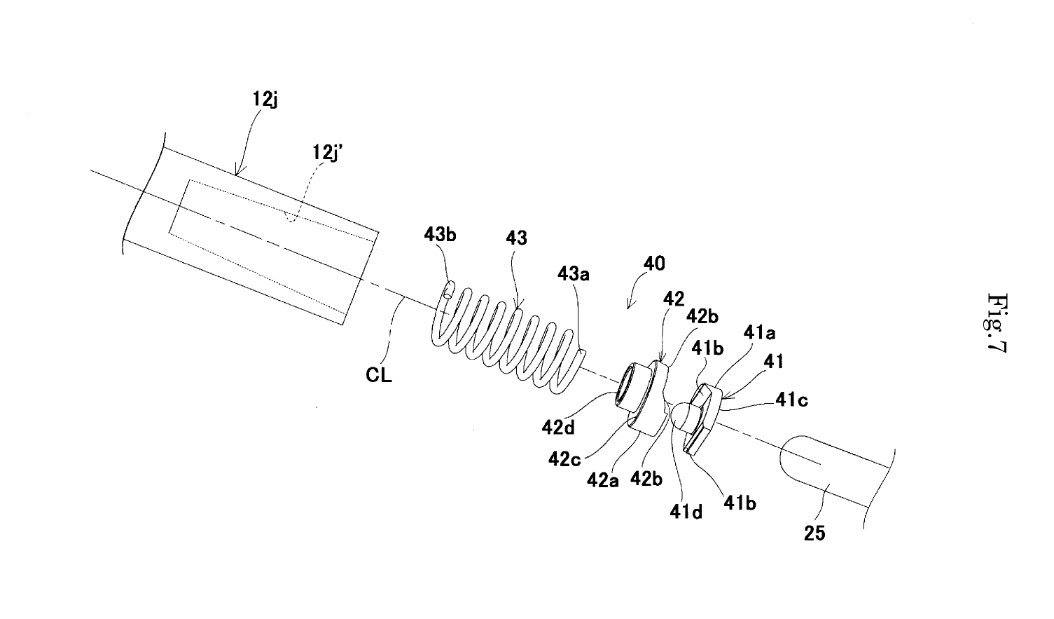

As illustrated in FIG. 7, the hysteresis generating mechanism 40 is structured with the slide guide path 12j′ formed at the cylindrical portion 12j of the second housing main body 12, the first slider 41, the second slider 42, and the urging spring 43.

As illustrated in FIG. 8, the slide guide path 12j′ is formed to define a cone-shaped inner wall face S having a central angle 2α against a center axis line CL (the inner wall face S being inclined to the center axis line CL by an angle α), that is, to be tapered in a direction of movement of the first slider 41 and the second slider 42 which are moved in association with depression of the accelerator pedal (toward the back side).

The first slider 41 is formed of resin material (e.g., high slidability material such as oil-containing polyacetal) and is provided, as illustrated in FIGS. 7 and 8, with a first slide face 41a having a curved face shape, a first inclined face 41b having a flat face shape, an engaging face 41c having a flat face shape, a center projection 41d, and the like.

The first slide face 41a is formed to have a curved face shape so as to be slidably contacted to the inner wall face S of the slide guide path 12j′.

The first inclined face 41b is formed to be engaged slidably with a second inclined face 42b of the second slider 42 as being inclined against the center axis line CL by a predetermined angle θ.

The engaging face 41c is formed so that the contact portion 25 of the pedal arm 20 is capable of being engaged therewith in a detachably attachable manner.

The center projection 41d is formed to be inserted to a center opening 42d of the second slider 42 as having a gap thereto, that is, to allow a predetermined amount of relative movement between the first slider 41 and the second slider 42 in a direction perpendicular to the center axis line CL.

The second slider 42 is formed of resin material (e.g., high slidability material such as oil-containing polyacetal) and is provided, as illustrated in FIGS. 7 and 8, with a second slide face 42a having a curved face shape, the second inclined face 42b having a flat face shape, a receiving face 42c having a flat face shape, the center opening 42d, and the like.

The second slide face 42a is formed to have a curved face shape so as to be slidably contacted to the inner wall face S of the slide guide path 12j′.

The second inclined face 42b is formed to be engaged slidably with the first inclined face 41b of the first slider 41 as being inclined against the center axis line CL by the predetermined angle θ.

The receiving face 42c is formed to receive one end part of the urging spring 43.

The center opening 42d is formed to accept the center projection 41d of the first slider 41 to allow the predetermined amount of relative movement between the first slider 41 and the second slider 42 in the direction perpendicular to the center axis line CL.

As illustrated in FIGS. 7 and 8, the urging spring 43 is a compression-type coil spring formed of spring steel or the like. The urging spring 43 is arranged in a state of being compressed having a predetermined compression amount with one end part 43a thereof being engaged with the receiving face 42c of the second slider 42 and the other end part 43b thereof being engaged with a bottom wall of the cylindrical portion 12j of the second housing main body 12. Accordingly, the urging spring 43 exerts urging force to return the pedal arm 20 to the rest position via the second slider 42 and the first slider 41 while providing a wedge action such that the first slider 41 and the second slider 42 are pressed toward the inner wall face S of the slide guide path 12j′ with pressing of the inclined face 42a of the second slider 42 to the inclined face 41a of the first slider 41.

Here, the angle θ of the first inclined face 41b and the second inclined face 42b is set to be, for example, about 45 degrees, and the angle α of the inner wall face S of the slide guide path 12j is set to be, for example, about one degree.

According to the hysteresis generating mechanism 40 having the abovementioned structure, in a case that the pedal arm 20 is depressed from the rest position toward the maximum depression position (full-open position) against the urging force of the return spring 30 (and the urging spring 43), the contact portion 25 presses the first slider 41 leftward in FIG. 8 against the urging force of the urging spring 43. Owing to the wedge action between the first inclined face 41b and the second inclined face 42b, the first slider 41 and the second slider 42 are moved against the urging force of the urging spring 43 while being pressed to the slide guide path 12j′ (inner wall face S). Consequently, friction force (slide friction) is caused at the first slide face 41a and the second slide face 42a against (the inner wall face S of) the slide guide path 12j′. The friction force is increased linearly in accordance with increase of the urging force of the urging spring 43.

Further, since the slide guide path 12j′ is tapered, the first slider 41 and the second slider 42 are relatively moved to be mutually closed to the center (center axis line CL) of the slide guide path 12j′. The relative movement causes friction force between the first inclined face 41b and the second inclined face 42b.

Accordingly, as the friction force during movement from the rest position toward the maximum depression position, the friction force between (the first inclined face 41b of) the first slider 41 and (the second inclined face 42b of) the second slider 42 is exerted in addition to the friction force between (the first slide face 41a of) the first slider 41 and the slide guide path 12j′ and the friction force between (the second slide face 42a of) the second slider 42 and the slide guide path 12j′. Consequently, the friction force can be increased by the amount thereof.

On the other hand, in a case that the pedal arm 20 is returned from the maximum depression position toward the rest position in accordance with the urging force of the return spring 30 (and the urging spring 43), the first slider 41 and the second slider 42 are relatively moved to be mutually apart from the center (center axis line CL) of the slide guide path 12j′ while the first slider 41 and the second slider 42 are moved rightward in FIG. 8 to an original position with the urging force of the urging spring 43. Accordingly, the second slider 42 and the first slider 41 are pushed back by the urging force of the urging spring 43 toward a release side to be free, so that the friction force (slide friction) caused by the wedge action between the first inclined face 41b and the second inclined face 42b is decreased and the urging force of the urging spring 43 is decreased. Consequently, the friction force is linearly decreased.

Here, even in a case that the first slider 41 and the second slider 42 are not returned as being stuck (locked) at a midpoint during the returning operation, the contact portion 25 is disengaged from (the engaging face 41c of) the first slider 41 owing to the urging force of the return spring 30. Accordingly, the pedal arm 20 (accelerator pedal) is reliably returned to the predetermined rest position.

Thus, since the friction force during returning operation is smaller than the friction force during depression operation, hysteresis can be generated at the pedaling force (pedaling load) entirely from the depressing operation to the returning operation.

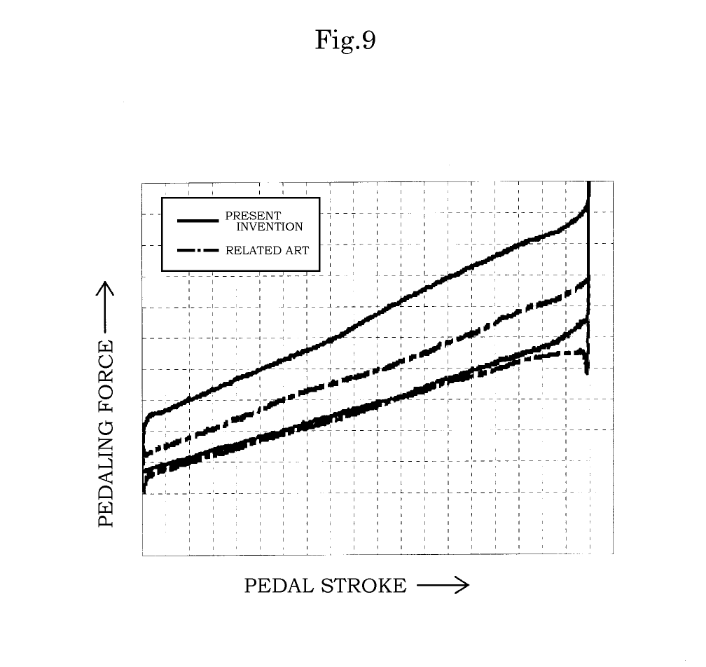

Accordingly, even when the hysteresis generating mechanism 40 (the slide guide path 12j′, the first slider 41, the second slider 42, the urging spring 43, and the like) is downsized, desired hysteresis can be obtained at the pedaling force while the friction force during depression is increased, as illustrated in FIG. 9, by the amount of the additional friction force due to the relative movement between the first slider 41 and the second slider 42.

Further, since the first slide face 41a of the first slider 41 and the second slide face 42a of the second slider 42 are slid with face contact in a curved face shape manner to the cone-shaped inner wall face S of the slide guide path 12j′, the first slider 41 and the second slider 42 can be automatically centered. Consequently, stable friction force can be obtained.

Furthermore, owing to the structure that the first slider 41, the second slider 42, and the urging spring 43 are arranged in the cylindrical portion 12j which is formed at the second housing main body 12, the hysteresis generating mechanism 40 can be structured only by fitting the urging spring 43 into the cylindrical portion 12j, fitting the second slider 42 from the outer side thereof, and fitting the first slider 41 further from the outer side thereof. Thus, it is possible to achieve simplification of assembling operation, simplification of the structure, and downsizing of the mechanism and the device.

As illustrated in FIGS. 2 to 5, the active control mechanism 50 includes the drive source 51 which generates rotational drive force caused by electromagnetic force as being arranged and held between the second housing main body 12 and the second housing cover 14, the return lever 52 which is disengageably engaged with the upper arm 23 of the pedal arm 20 as being directly connected to the drive source 51, and the like.

As illustrated in FIG. 5, the drive source 51 includes the rotor 51a which is rotated with electromagnetic force as integrally having the pair of permanent magnets, the coil 51b for magnetization, and the yoke 51c which forms a magnetic path.

As illustrated in FIG. 5, the rotor 51a includes the rotational shaft 51a′ which is supported as passing through the bearing hole 12g of the second housing main body 12 and the nut 51a″ for fastening. The return lever 52 is fixed at an end part of the rotational shaft 51a′ to be integrally rotated. Here, the rotor 51a is pivotably supported at a side of the nut 51a″ as well by the bearing portion 14d of the second housing cover 14.

The coil 51b is wound to a magnetization member (not illustrated) via a bobbin. A connection terminal of the coil 51b is connected to a terminal 11g embedded to the first housing main body 11 as passing through the opening portion 12h at the time of being assembled.

The yoke 51c is arranged at the attaching concave portion 12e of the second housing main body 12 and is sandwiched and held by the side wall portion 12a of the second housing main body 12 and the second housing cover 14 in a state of being covered so as not to be exposed except for a part thereof.

That is, the drive source 51 is a torque motor which rotates within a predetermined angular range about an axis line L2 being parallel to the axis line L as including the rotor 51a to which the return lever 52 is directly connected.

Here, not limited to a torque motor, it is possible to adopt a drive source having another structure as long as being capable of rotating the return lever 52 against pedaling force of the pedal arm 20.

As illustrated in FIGS. 4 and 5, the return lever 52 is formed so as to be directly connected to the rotational shaft 51a′ of the rotor 51a which is rotated about the axis line L2 and so that a roller 52a at the leading end part thereof is disengageably engaged with the rim portion 23b of the upper arm 23 of the pedal arm 20.

When drive force (rotational torque) is not exerted by the drive source 51, the return lever 52 is freely rotated as following swinging of the pedal arm 20, that is, as following movement of the upper arm 23 without exerting resistance force thereto. On the other hand, when drive force (rotational torque) is exerted by the drive source 51, the return lever 52 exerts push-back force to the upper arm 23 to push back the pedal arm 20 toward the rest position against pedaling force.

In the structure having the hysteresis generating mechanism 40 and the active control mechanism 50 as described above, the return lever 52 is formed to be engaged with the upper arm 23 and the contact portion 25 is formed at the lower arm 22. Accordingly, even in a case that the active control mechanism 50 is arranged in the housing, the device (housing) can be downsized as a whole by arranging the hysteresis generating mechanism 40 in an area at the lower arm 22.

The position sensor 60 is a non-contact type magnetic sensor. As illustrated in FIGS. 4 and 6, the position sensor 60 includes, in an area around the axis line L, the ring-shaped armature 61 formed of a magnetic material as being arranged (held) at the inner circumferential face of the cylindrical portion 21 of the pedal arm 20, the pair of arc-shaped permanent magnets 62 connected to the inner circumferential face of the armature 61, the stators 63 formed of a magnetic material as being arranged (held) to be embedded to the inside of the columnar portion 11c of the first housing main body 11, the two Hall elements 64 arranged between the stators 63 as being connected to a circuit formed on the control circuit board 80, and the like.

That is, the armature 61 and the permanent magnets 62 are relatively rotated against the stators 63 and the Hall elements 64 with rotation of the pedal arm 20, and then, variation of magnetic flux density due to the relative rotation movement is detected and output as a voltage signal by the Hall elements 64. Thus, an angular position of the pedal arm 20 can be detected.

The temperature sensor 70 is arranged to detect temperature of the coil 51b as being held at the outer side of the side wall portion 11a of the first housing main body 11. The circuit for processing signals of the temperature sensor 70 is arranged on the control circuit board 80 and is electrically connected to a circuit formed on the control circuit board 80 which is arranged at the outer side of the first housing main body 11 via terminals and the like. According to the above, temperature of the coil 51b is detected and ON/OFF of powering to the coil 51b is appropriately controlled based on the detected temperature. Thus, a fail-safe function can be ensured while preventing overheating.

As illustrated in FIGS. 2, 4, and 6, the control circuit board 80 includes a plurality of positioning holes 83a to which the positioning pins 11e of the first housing main body 11 are fitted, a plurality of holes 83b through which screws pass, a control circuit which includes a variety of electronic components (control units), a circuit which processes signals output from the Hall elements 64 of the position sensor 60, a circuit which processes signals output from the temperature sensor 70, terminals (bus bars) for electrical connection with the Hall elements 64, a terminal (bus bar) for electrical connection with the temperature sensor 70, and the like.

Here, the control circuit board 80 is arranged and held between the first housing main body 11 and the first housing cover 13 in a state of being covered so as not to be exposed to the outside.

Next, operation of the accelerator pedal device will be described.

First, when the accelerator pedal is at the rest position without being depressed by a driver, the upper arm 23 is contacted to the engaging projection 12d with the urging force of the return spring 30 and the pedal arm 20 is stopped at the rest position. At that time, the contact portion 25 of the pedal arm 20 is in a state of being disengageably engaged with the engaging face 41b of the first slider 41. Here, (the roller 52a of) the return lever 52 is in an engaged state with the upper arm 23 without exerting returning force.

When the accelerator pedal is depressed by the driver from the abovementioned state, the pedal arm 20 is rotated against the urging force of the return spring 30. Then, the pedal arm 20 is rotated to the maximum depression position (full-open position) while increasing friction load (the friction force between the first slide face 41a and the inner wall face S, the friction force between the second slide face 42a and the inner wall face S, and the friction force between the first inclined face 41b and the second inclined face 42b) generated by the hysteresis generating mechanism 40. Consequently, (the rim portion 23b of) the upper arm 23 is contacted to the full-open stopper 11i of the housing 10 (first housing main body 11) and the pedal arm 20 is stopped. During the depressing operation, the return lever 52 follows movement of the upper arm 23 without exerting any load (push-back force).

When the driver releases pedaling force, the pedal arm 20 is moved toward the rest position with the urging force of the return spring 30 while friction load (pedaling load) being smaller than the friction load (pedaling load) during depression is exerted to the operator (driver). Consequently, (the rim portion 23a of) the upper arm 23 is contacted to the engaging projection 12d of the housing 10 (second housing main body 12) and the pedal arm 20 is stopped. During the returning operation, the return lever 52 follows movement of the upper arm 23 without exerting any load (push-back force).

That is, as the friction force during movement from the rest position toward the maximum depression position, the friction force between (the first inclined face 41b of) the first slider 41 and (the second inclined face 42b of) the second slider 42 is exerted in addition to the friction force between the first slider 41 and the slide guide path 12j′ (inner wall face S) and the friction force between the second slider 42 and the slide guide path 12j′ (inner wall face S). Consequently, the friction force can be increased by the amount thereof. On the other hand, when the accelerator pedal is returned and the pedal arm 20 is rotated in the returning direction and is moved from the maximum depression position toward the rest position while the second slider 42 and the first slider 41 are pushed back in accordance with the urging force of the urging spring 43, the friction force can be decreased owing to movement of the first slider 41 and the second slider 42 toward the release side to be free. Accordingly, even when the hysteresis generating mechanism 40 (the slide guide path 12j′, the first slider 41, the second slider 42, the urging spring 43, and the like) is downsized, desired hysteresis can be obtained at the pedaling force while the friction force during depression is increased.

On the other hand, when it is determined (by a separated inter-vehicular distance detection system or the like), for example, that danger avoidance or danger notification is required (that is, under predetermined conditions) in a state that the accelerator pedal is depressed by the driver, the drive source 51 of the active control mechanism 50 is activated and is drive-controlled to push-back the pedal arm 20 toward the rest position against the pedaling force of the driver while the return lever 52 generates rotational torque (push-back force). Such control is performed based on control signals from (a control unit on) the control circuit board 80 and output signals from the position sensor 60, and the like.

Further, since the push-back force of the return lever 52 is directly exerted to (the upper arm 23 of) the pedal arm 20, the hysteresis generating mechanism 40 can be prevented from being influenced thereby and desired hysteresis characteristics at the pedaling force can be obtained.

Further, since the return lever 52 is disengageable from the upper arm 23 of the pedal arm 20, it is possible to reliably ensure returning of the pedal arm 20 to a safe side (the rest position) even if the active control mechanism 50 fails.

Further, since the urging force is exerted directly from the return spring 30, it is possible to reliably ensure returning of the pedal arm 20 to the safe side (the rest position) even if the hysteresis generating mechanism 40 and the active control mechanism 50 fail.

According to the accelerator pedal device having the abovementioned structure, pedaling force with desired hysteresis generated by the hysteresis generating mechanism 40 can be obtained while a driver operates an accelerator pedal and the pedal arm 20 is rotated between the rest position and the maximum depression position. Further, under predetermined conditions (for example, in a case that danger avoidance, danger notification or the like is required during operation of a vehicle), it is possible to generate push-back force to push back the pedal arm 20 against pedaling force of the driver with operation of the active control mechanism 50.

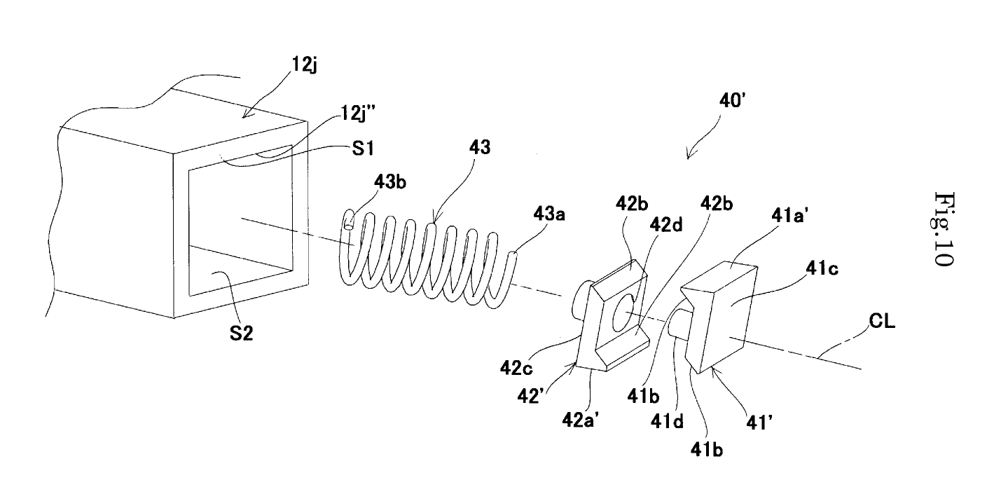

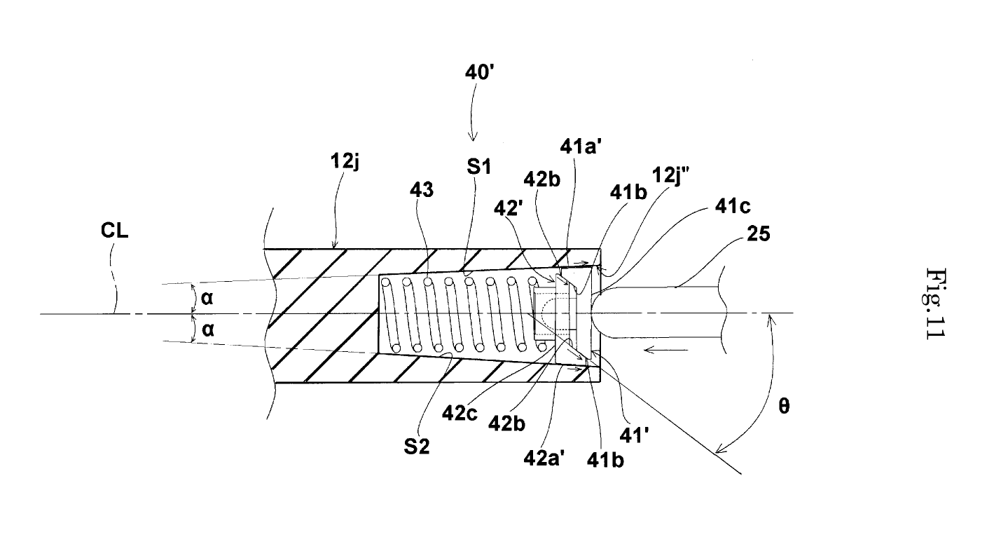

FIGS. 10 and 11 illustrate another embodiment of a hysteresis generating mechanism. The same reference is given to the same structure of the abovementioned embodiment and description thereof will not be repeated.

In this embodiment, as illustrated in FIGS. 10 and 11, a hysteresis generating mechanism 40′ is structured with a slide guide path 12j″ formed at a cylindrical portion 12j of the second housing main body 12, a first slider 41′, a second slider 42′, and the urging spring 43.

As illustrated in FIGS. 10 and 11, the slide guide path 12j″ is formed to define a first inclined inner wall face S1 having a flat face shape with the angle α upward from the center axis line CL and a second inclined inner wall face S2 having a flat face shape with the angle α downward from the center axis line CL, that is, to be tapered in a direction of movement of the first slider 41′ and the second slider 42′ which are moved in association with depression of the accelerator pedal (toward the back side).

The first slider 41′ is formed of resin material (e.g., high slidability material such as oil-containing polyacetal) and is provided, as illustrated in FIGS. 10 and 11, with a first slide face 41a′ having a flat face shape, the first inclined face 41b, the engaging face 41c, the center projection 41d, and the like.

The first slide face 41a′ is formed to have a flat face shape so as to be slidably contacted to the first inclined inner wall face S1 of the slide guide path 12j″.

The second slider 42′ is formed of resin material (e.g., high slidability material such as oil-containing polyacetal) and is provided, as illustrated in FIGS. 10 and 11, with a second slide face 42a′ having a flat face shape, the second inclined face 42b, the receiving face 42c, the center opening 42d, and the like.

The second slide face 42a′ is formed to have a flat face shape so as to be slidably contacted to the second inclined inner wall face S2.

According to the hysteresis generating mechanism 40′ having the abovementioned structure, in a case that the pedal arm 20 is depressed from the rest position toward the maximum depression position (full-open position) against the urging force of the return spring 30 (and the urging spring 43), the contact portion 25 presses the first slider 41′ leftward in FIG. 11 against the urging force of the urging spring 43. Owing to the wedge action between the first inclined face 41b and the second inclined face 42b, the first slider 41′ and the second slider 42′ are moved against the urging force of the urging spring 43 while being pressed to the slide guide path 12j″ (the first inclined inner wall face S1 and the second inclined inner wall face S2). Consequently, friction force (slide friction) is caused at the first slide face 41b and the second slide face 42b against the slide guide path 12j′ (the first inclined inner wall face S1 and the second inclined inner wall face S2). The friction force is increased linearly in accordance with increase of the urging force of the urging spring 43.

Further, since the slide guide path 12j″ (the first inclined inner wall face S1 and the second inclined inner wall face S2) is tapered, the first slider 41′ and the second slider 42′ are relatively moved to be mutually closed to the center (center axis line CL) of the slide guide path 12j″. The relative movement causes friction force between the first inclined face 41b and the second inclined face 42b.

Accordingly, as the friction force during movement from the rest position toward the maximum depression position, the friction force between (the first inclined face 41b of) the first slider 41′ and (the second inclined face 42b of) the second slider 42′ is exerted in addition to the friction force between the first slider 41′ and the slide guide path 12j″ (first inclined inner wall face S1) and the friction force between the second slider 42′ and the slide guide path 12j″ (second inclined inner wall face S2). Consequently, the friction force can be increased by the amount thereof.

On the other hand, in a case that the pedal arm 20 is returned from the maximum depression position toward the rest position in accordance with the urging force of the return spring 30 (and the urging spring 43), the first slider 41′ and the second slider 42′ are relatively slid to be mutually apart from the center (center axis line CL) of the slider guide path 12j″ while the first slider 41′ and the second slider 42′ are moved rightward in FIG. 11 to an original position with the urging force of the urging spring 43. Accordingly, the second slider 42′ and the first slider 41′ are pushed back by the urging force of the urging spring 43 toward a release side to be free, so that the friction force (slide friction) caused by the wedge action between the first inclined face 41b and the second inclined face 42b is decreased and the urging force of the urging spring 43 is decreased. Consequently, the friction force is linearly decreased.

In the present embodiment, since the first slide face 41a′ of the first slider 41′ is slid with face contact in a flat face shape manner to the first inclined inner wall face S1 of the slide guide path 12j″ and the second slide face 42a′ of the second slider 42′ is slid with face contact in a flat face shape manner to the second inclined inner wall face S2 of the slide guide path 12j″, occurrence of sticking (biting) and the like can be prevented and stable friction force can be obtained with smooth sliding operation.

In the abovementioned embodiments, description is performed on the case that slide faces (the inner wall faces of the slide guide path, the first slide face, the second slide face, the first inclined face, the second inclined face) causing friction forces of the hysteresis generating mechanism 40, 40′ are face contacted as being face-shaped. However, not limited to this, it is also possible to adopt a structure to form dimples or the like on the abovementioned faces.

In the abovementioned embodiments, description is performed on the case that the pedal arm 20 is arranged separately from the accelerator pedal which is swingably supported by a floor face of a vehicle or the like and is moved in association with the accelerator pedal. However, it is also possible to adopt the present invention to a structure with a pedal arm which integrally includes an accelerator pedal.

In the abovementioned embodiments, description is performed on the case that the housing 10 is structured with the first housing main body 11, the second housing main body 12, the first housing cover 13, and the second housing cover 14. However, not limited to this, it is also possible to adopt a structure with a dual-partitioning housing main body.

### INDUSTRIAL APPLICABILITY

As described above, according to the accelerator pedal device of the present invention, it is possible to obtain desired hysteresis characteristics while achieving simplification of structure, reduction in component count, cost reduction, downsizing of the whole device, downsizing of the hysteresis generating mechanism, and the like. Therefore, the present invention is useful for motorcycles and other vehicles as well as being capable of being applied to automobiles.

### EXPLANATION OF REFERENCES

L Axis line
10 Housing
11 First housing main body
11a Side wall portion
11b Bearing portion
11c Columnar portion
11d Connection hole
11e Positioning pin
11f Screw hole
11g Terminal
11h Connecting piece
11i Full-open stopper
12 Second housing main body
12a Side wall portion
12b Bearing portion
12d Fitting projection
12e Attaching concave portion
12f Screw hole
12g Bearing hole
12h Opening portion
12i Receiving portion
12j Cylindrical portion
12j′, 12j″ Slide guide path
S Cone-shaped inner wall face
S1 First inclined inner wall face
S2 Second inclined inner wall face
12k Screw hole
12m Connection pawl
13 First housing cover
13a Side wall portion
13b Screw hole
14 Second housing cover
14a Side wall portion
14b Screw hole
14c Concave portion
14d Bearing portion
20 Pedal arm
21 Cylindrical portion
22 Lower arm
23 Upper arm
24 Receiving portion
25 Contact portion
30 Return spring
40, 40′ Hysteresis generating mechanism
41, 41′ First slider
41a, 41a′ First slide face
41b First inclined face
41c Engaging face
41d Center projection
42, 42′ Second slider
42a, 42a′ Second slide face
42b Second inclined face
42c Receiving face
42d Center opening
43 Urging spring
50 Active control mechanism
51 Drive source
51a Rotor
51a′ Rotational shaft
51b Coil for magnetization
51c Yoke
52 Return lever
52a Roller
60 Position sensor
70 Temperature sensor
80 Control circuit board
90 Connector

1. An accelerator pedal device, comprising:
a pedal arm which is moved in association with an accelerator pedal,
a housing which supports the pedal arm between a rest position and a maximum depression position as being pivotable about a predetermined axis line; and
a hysteresis generating mechanism for generating hysteresis at pedaling force of the accelerator pedal as including a slide guide path which is formed in the housing, a first slider which is engaged with the pedal arm for receiving pedaling force as being slidably arranged in the slide guide path and which includes a first inclined face inclined against a movement direction of the first slider, a second slider which is slidably arranged in the slide guide path and which includes a second inclined face contacted to the first inclined face, and an urging spring which exerts urging force in a direction opposing to the pedaling force as being engaged with the second slider,
wherein the slide guide path is formed as being tapered in a direction of movement of the first slider and the second slider which are moved in association with depression of the accelerator pedal.

2. The accelerator pedal device according to claim 1,
wherein the first slider includes a first slide face which is slidably contacted to the slide guide path,
the second slider includes a second slide face which is slidably contacted to the slide guide path, and
the slide guide path includes an inner wall face which slidably guides the first slide face and the second slide face.

3. The accelerator pedal device according to claim 2,
wherein the first slide face and the second slide face are formed as being flat-face-shaped, and
the slide guide face is formed to define a first inclined inner face wall having a flat face shape to which the first slide face of the first slider is slidably contacted and a second inclined inner wall face having a flat face shape to which the second slide face of the second slider is slidably contacted.

4. The accelerator pedal device according to claim 2,
wherein the first slide face and the second slide face are formed as being curved-face-shaped, and
the slide guide face is formed to define a cone-shaped inner wall face to which the first slide face of the first slider and the second slide face of the second slider are slidably contacted.

5. The accelerator pedal device according to claim 1,
wherein the housing includes a cylindrical portion which defines the slide guide path with one end thereof opened, and
the first slider, the second slider, and the urging spring are arranged at the cylindrical portion.

6. The accelerator pedal device according to claim 1, further comprising a return spring which exerts urging force to return the pedal arm to the rest position,
wherein the pedal arm includes a contact portion which is disengageably contacted to the first slider.

7. The accelerator pedal device according to claim 6, further comprising an active control mechanism including a return lever which exerts returning force to the pedal arm as being contacted thereto for controlling the pedal arm to be pushed back toward the rest position under predetermined conditions, and a drive source which drives the return lever,
wherein the pedal arm includes an upper arm which is positioned above the predetermined axis line, and a lower arm which is positioned below the predetermined axis line,
the return lever is formed to be engaged with the upper arm, and
the contact portion is formed at the lower arm.

8. The accelerator pedal device according to claim 2,
wherein the housing includes a cylindrical portion which defines the slide guide path with one end thereof opened, and
the first slider, the second slider, and the urging spring are arranged at the cylindrical portion.

9. The accelerator pedal device according to claim 3,
wherein the housing includes a cylindrical portion which defines the slide guide path with one end thereof opened, and
the first slider, the second slider, and the urging spring are arranged at the cylindrical portion.

10. The accelerator pedal device according to claim 4,
wherein the housing includes a cylindrical portion which defines the slide guide path with one end thereof opened, and
the first slider, the second slider, and the urging spring are arranged at the cylindrical portion.

11. The accelerator pedal device according to claim 2, further comprising a return spring which exerts urging force to return the pedal arm to the rest position,
wherein the pedal arm includes a contact portion which is disengageably contacted to the first slider.

12. The accelerator pedal device according to claim 3, further comprising a return spring which exerts urging force to return the pedal arm to the rest position,
wherein the pedal arm includes a contact portion which is disengageably contacted to the first slider.

13. The accelerator pedal device according to claim 4, further comprising a return spring which exerts urging force to return the pedal arm to the rest position,
wherein the pedal arm includes a contact portion which is disengageably contacted to the first slider.

14. The accelerator pedal device according to claim 5, further comprising a return spring which exerts urging force to return the pedal arm to the rest position,
wherein the pedal arm includes a contact portion which is disengageably contacted to the first slider.
